(19) United States
(12) Patent Application Publication
(10) Pub. No.: US 2023/0234344 A1
(43) Pub. Date: Jul. 27, 2023

(54) VEHICLE INTERIOR PART AND HEATED MOULD COMPRESSION FORMING PROCESS THEREOF

(71) Applicant: WUXI GISSING AUTO ACOUSTIC PARTS TECH. CO., LTD., Wuxi (CN)

(72) Inventors: Wei Gong, Wuxi (CN); Keda Zhu, Wuxi (CN); Yan Huang, Wuxi (CN); Chunlei Yuan, Wuxi (CN)

(21) Appl. No.: 18/191,272

(22) Filed: Mar. 28, 2023

Related U.S. Application Data
(63) Continuation of application No. 17/048,168, filed on Oct. 16, 2020, now abandoned.

(30) Foreign Application Priority Data
Sep. 6, 2019 (CN) 201910843821.4

(51) Int. Cl. B32B 27/12; B29C 70/34; B32B 3/26; B32B 5/26; B32B 7/12; B32B 27/40; B32B 37/12

(52) U.S. Cl. CPC B32B 27/12; B29C 70/34; B32B 3/266; B32B 5/26; B32B 7/12; B32B 27/40; B32B 37/1284; B29K 2075/00

(57) ABSTRACT

A vehicle interior part includes a substrate, a first outer layer, a second outer layer, an upper reinforcement layer, a lower reinforcement layer, and a bottom fabric layer, where a first surface and a second surface of the substrate are bonded to a first surface of the upper reinforcement layer and a first surface of the lower reinforcement layer, respectively, a second surface of the upper reinforcement layer is bonded to a first surface of the first outer layer, a second surface of the first outer layer is bonded to the second outer layer, and a second surface of the lower reinforcement layer is bonded to the bottom fabric layer.

### TECHNICAL FIELD

The present application relates to the field of vehicle interior parts, for example, a vehicle interior part and a heated mould compression forming process thereof.

### BACKGROUND

With the rapid development of modern society, an energy crisis is increasingly serious, and energy saving and environmental protection are two major issues currently. Interior parts of vehicles such as airplanes, automobiles, ships and yachts can not only decorate internal spaces of the vehicles, but also enhance strength of the interior of the vehicles. In the related art, the interior parts of the vehicles are processed with PC+ABS, ABS+30% GF or galvanized metal sheets, and the interior parts are heavy in weight, high in cost, and complicated in forming process; and it is easy for the interior parts to match with sheet metals improperly and cause abnormal noise when the interior parts are loaded.

### SUMMARY

The present application further provides a heated mould compression forming process for a vehicle interior part which can simplify a manufacturing process for the vehicle interior part.

An embodiment provides a vehicle interior part, including: a substrate, a first outer layer, a second outer layer, an upper reinforcement layer, a lower reinforcement layer, and a bottom fabric layer, where a first surface and a second surface of the substrate are bonded to a first surface of the upper reinforcement layer and a first surface of the lower reinforcement layer, respectively, a second surface of the upper reinforcement layer is bonded to the first outer layer, a second surface of the first outer layer is bonded to the second outer layer, and a second surface of the lower reinforcement layer is bonded to the bottom fabric layer.

The upper reinforcement layer and the lower reinforcement layer are each made of at least one layer of glass fiber filament or glass fiber mat, and the second outer layer is made of a knitted fabric, a chamois fabric, a needled mat, a flock mat, or a loop-pile mat.

An embodiment provides a heated mould compression forming process for a vehicle interior part, including steps described below.

A first surface and a second surface of a substrate are coated with glue respectively.

Pure water or a catalyst is uniformly sprayed on the first surface and the second surface of the substrate which are coated with the glue, where a total spraying amount of the first surface and the second surface of the substrate is controlled within a range from 50 g/m² to 450 g/m².

The first outer layer, the upper reinforcement layer, the substrate, the lower reinforcement layer, and the bottom fabric layer are stacked in sequence from top to bottom.

Stacked forming materials are placed into a pressing mould for compression forming, to obtain a semi-finished vehicle interior part; where during the compression forming, a temperature of an upper mould is controlled within a range from 110° C. to 140° C., a temperature of a lower mould is controlled within a range from 110° C. to 140° C., forming pressure is controlled within a range from 5 MPa to 16 MPa, and forming time is controlled within a range from 10 seconds to 80 seconds.

The semi-finished vehicle interior part is placed on a cooling tooling fixture for vacuum adsorption, cooling and shaping at room temperature; where cooling time is controlled within a range from 40 seconds to 50 seconds, and a vacuum degree is controlled within a range from −2 mbar to −5 mbar.

The cooled and shaped semi-finished vehicle interior part is placed on a workbench for burrs to be removed.

The semi-finished vehicle interior part with the burrs removed is placed in a mould or a device, and the second outer layer is bonded to the semi-finished vehicle interior part with the burrs removed, to obtain a finished vehicle interior part; where during bonding the second outer layer to the semi-finished vehicle interior part with the burrs removed, the temperature of the upper mould is controlled within a range from 50° C. to 140° C., the temperature of the lower mould is controlled within a range from 50° C. to 140° C., the forming pressure is controlled within a range from 2 MPa to 16 MPa, and the forming time is controlled within a range from 10 seconds to 80 seconds.

The vehicle interior part provided by the present application adopts a raw material including a PU sheet and a glass fiber. The vehicle interior part is light in weight, reduces production costs, is energy saving and environmentally friendly, complies with a trend of lightweight development of the industry; meanwhile, the heated mould compression forming process is adopted, which has simple process steps, is convenient to operate, and improves stability and production efficiency.

### BRIEF DESCRIPTION OF THE DRAWINGS

FIG. 1 is a structural schematic diagram of a vehicle interior part according to embodiment one of the present application;

FIG. 2 is a structural schematic diagram of a vehicle interior part according to embodiment two of the present application;

FIG. 3 is a structural schematic diagram of a vehicle interior part according to embodiment three of the present application;

FIG. 4 is a structural schematic diagram of a vehicle interior part according to embodiment four of the present application;

FIG. 5 is a flowchart of a heated mould compression forming process for a vehicle interior part according to embodiment one and embodiment two of the present application; and

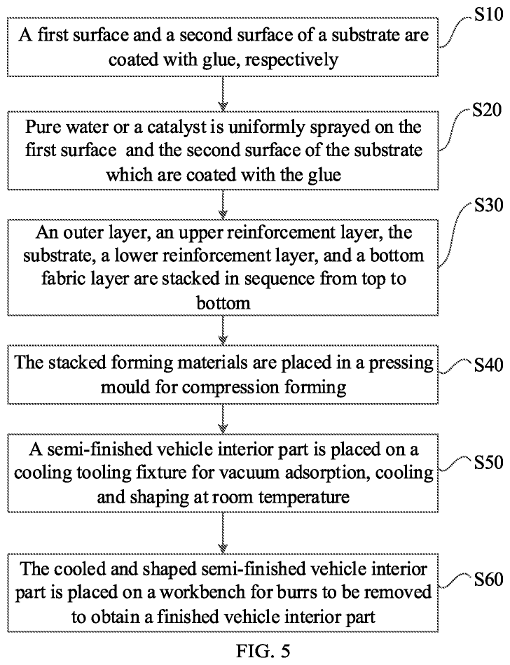

FIG. 6 is a flowchart of a heated mould compression forming process for a vehicle interior part according to embodiment three and embodiment four of the present application.

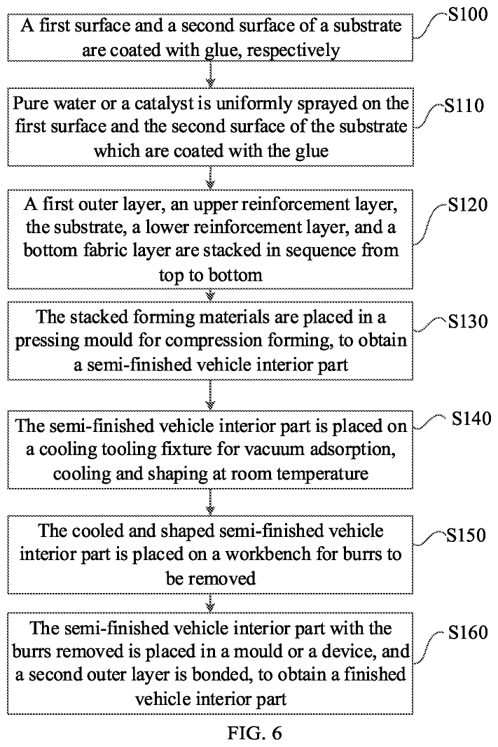

### DETAILED DESCRIPTION

To facilitate a better understanding of the present application, a more complete description of the present application is provided below with reference to the drawings. The drawings illustrate exemplary embodiments of the present application. However, the present application may be implemented in many different forms, and is not limited to the embodiments described herein. Conversely, these embodiments are provided for a more through and comprehensive understanding of the content disclosed by the present application. It is to be noted that when a component is described as being “fixed to” another component, it may be directly on the other component or intervening components may be present. When a component is described as being “connected to” another component, it may be directly connected to the other component or intervening components may be present. The terms “vertical”, “horizontal”, “left”, “right” and the like used herein are only used for an illustrative purpose and are not the unique embodiments. Unless otherwise defined, all technical and scientific terms used herein have the same meanings as those commonly understood by those skilled in the art to which the present application pertains. The terms used in the specification of the present application are only used for describing specific embodiments and not intended to limit the present application. The term “and/or” used herein includes any or all combinations of one or more listed associated items.

The present application provides a cabin interior part, which may be widely applied to airplanes, ships, yachts and automobiles. The interior part includes, for example, a guard plate (such as an A upper and lower column guard plate, a B upper and lower column guard plate, or a C upper and lower column guard) and a door panel (such as a door panel, an instrument panel or a guard panel) used as automobile interiors. An automobile interior part may be, for example, a roof, a rear shelf, a carpet, a luggage trim, a spare board, and other local structures that have reinforcement and support functions and substitute a plastic interior part.

### Embodiment One

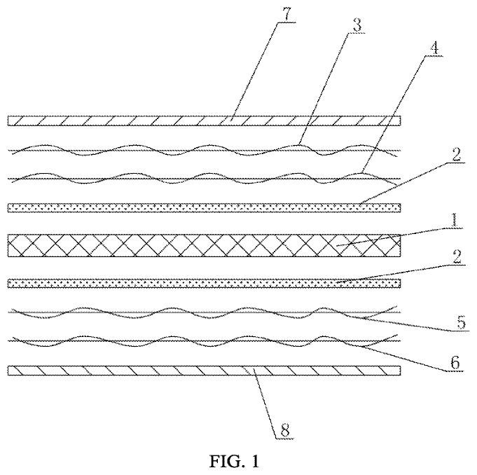

Referring to FIG. 1, FIG. 1 is a structural schematic diagram of a vehicle interior part according to an embodiment of the present application.

In this embodiment, the vehicle interior part includes a PU sheet 1 (i.e., a substrate), and an upper reinforcement layer and a lower reinforcement layer are separately bonded on two sides of the PU sheet 1 through a glue layer 2. The upper reinforcement layer and the lower reinforcement layer both adopt a double-layer structure. The upper reinforcement layer includes a first upper glass fiber layer 3 and a second upper glass fiber layer 4, and the lower reinforcement layer includes a first lower glass fiber layer 5 and a second lower glass fiber layer 6. A surface of the first upper glass fiber layer 3 is bonded with an upper non-woven fabric 7 (i.e., an outer layer), and a surface of the second lower glass fiber layer 6 is bonded with a lower non-woven fabric 8 (i.e., a bottom fabric layer). The PU sheet 1 has a thickness in a range from 2 mm to 10 mm, such as 2 mm, 3 mm, 4 mm, 5 mm, 6 mm, 7 mm, 8 mm, 9 mm, and 10 mm. The PU sheet 1 has a weight per unit area in a range from 30 g/m² to 500 g/m², such as 30 g/m², 50 g/m², 100 g/m², 150 g/m², 200 g/m², 250 g/m², 300 g/m², 350 g/m², 400 g/m², 450 g/m², and 500 g/m. A glue volume of the glue layer 2 is controlled within a range from 50 g/m² to 450 g/m², such as 50 g/m², 100 g/m², 150 g/m², 200 g/m², 250 g/m², 300 g/m², 350 g/m², 400 g/m², and 450 g/m².

In an embodiment, a heated mould compression forming process for the vehicle interior part includes steps described below.

In S10, a first surface and a second surface of the PU sheet 1 are coated with glue, respectively.

The PU sheet 1 has a thickness of 2 mm and a weight per unit area of 30 g/m², and a total glue volume of the first surface and the second surface of the PU sheet 1 is controlled at 50 g/m². A main component of the glue coated is a polyurethane compound.

In S20, pure water or a catalyst is uniformly sprayed on the first surface and the second surface of the PU sheet 1 which are coated with the glue.

An amount of the pure water or the catalyst sprayed on of the first surface of the PU sheet 1 and an amount of the pure water or the catalyst sprayed on the second surface of the PU sheet 1 each are controlled at 50 g/m².

In S30, the upper non-woven fabric 7, the first upper glass fiber layer 3, the second upper glass fiber layer 4, the PU sheet 1, the first lower glass fiber layer 5, the second lower glass fiber layer 6, and the lower non-woven fabric 8 are stacked in sequence from top to bottom.

In S40, the stacked forming materials are placed in a pressing mould for compression forming.

During the compression forming, a temperature of an upper mould is controlled at 110° C., a temperature of a lower mould is controlled at 110° C., forming pressure is controlled at 5 MPa, forming time is controlled at 10 seconds, and a semi-finished vehicle interior part is obtained after the compression forming.

In S50, the semi-finished vehicle interior part after the compression processing is placed on a cooling tooling fixture for vacuum adsorption, cooling and shaping at room temperature.

Cooling time is controlled at 40 seconds, and a vacuum degree is controlled at −2 mbar.

In S60, the cooled and shaped semi-finished vehicle interior part is placed on a workbench for burrs to be removed to obtain a finished vehicle interior part.

In an embodiment, a heated mould compression forming process for the vehicle interior part includes steps described below.

A first surface and a second surface of the PU sheet 1 are coated with glue, respectively.

The PU sheet 1 has a thickness of 6 mm and a weight per unit area of 250 g/m², and a total glue volume of the first surface and the second surface of the PU sheet 1 is controlled at 250 g/m². A main component of the glue coated is a polyurethane compound.

Pure water or a catalyst is uniformly sprayed on the first surface and the second surface of the PU sheet 1 which are coated with the glue.

An amount of the pure water or the catalyst sprayed on of the first surface of the PU sheet 1 and an amount of the pure water or the catalyst sprayed on the second surface of the PU sheet 1 each are controlled at 250 g/m².

The upper non-woven fabric 7, the first upper glass fiber layer 3, the second upper glass fiber layer 4, the PU sheet 1, the first lower glass fiber layer 5, the second lower glass fiber layer 6, and the lower non-woven fabric 8 are stacked in sequence from top to bottom.

The stacked forming materials are placed in a pressing mould for compression forming.

During the compression forming, a temperature of an upper mould is controlled at 125° C., a temperature of a lower mould is controlled at 125° C., forming pressure is controlled at 10 MPa, forming time is controlled at 45 seconds, and a semi-finished vehicle interior part is obtained after the compression forming.

The semi-finished vehicle interior part is placed on a cooling tooling fixture for vacuum adsorption, cooling and shaping at room temperature.

Cooling time is controlled at 45 seconds, and a vacuum degree is controlled at −3.5 mbar.

The cooled and shaped semi-finished vehicle interior part is placed on a workbench for burrs to be removed to obtain a finished vehicle interior part.

In an embodiment, a heated mould compression forming process for the vehicle interior part includes steps described below.

A first surface and a second surface of the PU sheet 1 are coated with glue, respectively.

The PU sheet 1 has a thickness of 10 mm and a weight per unit area of 500 g/m², and a total glue volume of the first surface and the second surface of the PU sheet 1 is controlled at 450 g/m². A main component of the glue coated is a polyurethane compound.

Pure water or a catalyst is uniformly sprayed on the first surface and the second surface of the PU sheet 1 which are coated with the glue.

An amount of the pure water or the catalyst sprayed on of the first surface of the PU sheet and an amount of the pure water or the catalyst sprayed on the second surface of the PU sheet each are controlled at 450 g/m².

The upper non-woven fabric 7, the first upper glass fiber layer 3, the second upper glass fiber layer 4, the PU sheet 1, the first lower glass fiber layer 5, the second lower glass fiber layer 6, and the lower non-woven fabric 8 are stacked in sequence from top to bottom.

The stacked forming materials are placed in a pressing mould for compression.

During the compression forming, a temperature of an upper mould is controlled at 140° C., a temperature of a lower mould is controlled at 140° C., forming pressure is controlled at 16 MPa, forming time is controlled at 80 seconds, and a semi-finished vehicle interior part is obtained after the compression forming.

The semi-finished vehicle interior part is placed on a cooling tooling fixture for vacuum adsorption, cooling and shaping at room temperature.

Cooling time is controlled at 50 seconds, and a vacuum degree is controlled at −5 mbar.

The cooled and shaped semi-finished vehicle interior part is placed on a workbench for burrs to be removed to obtain a finished vehicle interior part.

### Embodiment Two

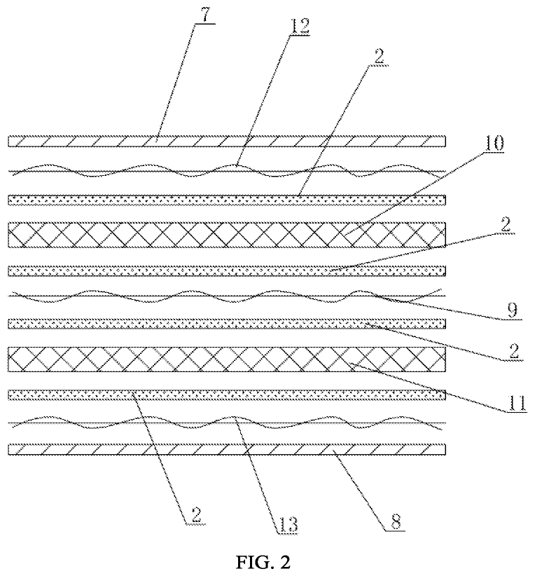

Referring to FIG. 2, FIG. 2 is a structural schematic diagram of a vehicle interior part according to an embodiment of the present application.

In this embodiment, the vehicle interior part includes a substrate. The substrate includes a middle glass fiber layer 9, and an upper PU sheet 10 (i.e., an upper core material) and a lower PU sheet 11 (i.e., a lower core material) are bonded on upper and lower surfaces of the middle glass fiber layer 9 through a glue layer 2, respectively, For example, at least one layer of a core materials is made of high molecular polymer material with an open cell structure, i.e., an open cell foam. A surface of the upper PU sheet 10 is bonded with an upper glass fiber layer 12 through a glue layer 2, a surface of the upper glass fiber layer 12 is bonded with an upper non-woven fabric 7, a bottom surface of the lower PU sheet 11 is bonded with a lower glass fiber layer 13 through a glue layer 2, and a bottom surface of the lower glass fiber layer 13 is bonded with a lower non-woven fabric 8. The upper PU sheet 10 and the lower PU sheet 11 each have a thickness in a range from 2 mm to 10 mm, such as 2 mm, 3 mm, 4 mm, 5 mm, 6 mm, 7 mm, 8 mm, 9 mm, and 10 mm. The upper PU sheet 10 and the lower PU sheet 11 each have a weight per unit area in a range from 30 g/m² to 500 g/m², such as 30 g/m², 50 g/m², 100 g/m², 150 g/m², 200 g/m², 250 g/m², 300 g/m², 350 g/m², 400 g/m², 450 g/m², and 500 g/m². And a glue volume of the glue layer 2 is controlled within a range from 50 g/m² to 450 g/m², such as 50 g/m², 100 g/m², 150 g/m², 200 g/m², 250 g/m², 300 g/m², 350 g/m², 400 g/m², and 450 g/m².

In an embodiment, a heated mould compression forming process for the vehicle interior part includes steps described below.

The upper PU sheet 10 and the lower PU sheet 11 are coated with glue, respectively.

The upper PU sheet 10 and the lower PU sheet 11 each have a thickness of 2 mm and a weight per unit area of 30 g/m², and a glue volume of an upper or lower surface of the upper PU sheet 10 and a gluer volume of an upper or lower surface of the lower PU sheet 11 each are controlled at 50 g/m². A main component of the glue coated is a polyurethane compound.

Pure water or a catalyst is uniformly sprayed on the upper and lower surfaces of the upper PU sheet 10 and the upper and lower surfaces of the lower PU sheet 11 which are coated with the glue.

An amount of the pure water or the catalyst sprayed on the upper or lower surface of the upper PU sheet 10 and an amount of the pure water or the catalyst sprayed on the upper or lower surface of the lower PU sheet 11 each are controlled at 50 g/m².

The upper non-woven fabric 7, the upper glass fiber layer 12, the upper PU sheet 10, the middle glass fiber layer 9, the lower PU sheet 11, the lower glass fiber layer 13, and the lower non-woven fabric 8 are stacked in sequence from top to bottom.

The stacked forming materials are placed in a pressing mould for compression forming.

During the compression forming, a temperature of an upper mould is controlled at 110° C., a temperature of a lower mould is controlled at 110° C., forming pressure is controlled at 5 MPa, forming time is controlled at 10 seconds, and a semi-finished vehicle interior part is obtained after the compression forming.

The semi-finished vehicle interior part is placed on a cooling tooling fixture for vacuum adsorption, cooling and shaping at room temperature.

Cooling time is controlled at 40 seconds, and a vacuum degree is controlled at −2 mbar.

The cooled and shaped semi-finished vehicle interior part is placed on a workbench for burrs to be removed to obtain a finished vehicle interior part.

In an embodiment, a heated mould compression forming process for the vehicle interior part includes steps described below.

The upper PU sheet 10 and the lower PU sheet 11 are coated with glue, respectively.

The upper PU sheet 10 and the lower PU sheet 11 each have a thickness of 6 mm and a weight per unit area of 250 g/m², and a glue volume of an upper or lower surface of the upper PU sheet 10 and a glue volume of an upper or lower surface of the lower PU sheet 11 each are controlled at 250 g/m². A main component of the glue coated is a polyurethane compound.

Pure water or a catalyst is uniformly sprayed on the upper and lower surfaces of the upper PU sheet 10 and the upper and lower surfaces of the lower PU sheet 11 which are coated with the glue. An amount of the pure water or the catalyst sprayed on the upper or lower surface of the upper PU sheet 10 and an amount of the pure water or the catalyst sprayed on the upper or lower surface of the lower PU sheet 11 each are controlled at 250 g/m².

The upper non-woven fabric 7, the upper glass fiber layer 12, the upper PU sheet 10, the middle glass fiber layer 9, the lower PU sheet 11, the lower glass fiber layer 13, and the lower non-woven fabric 8 are stacked in sequence from top to bottom.

The stacked forming materials are placed in a pressing mould for compression forming.

During the compression forming, a temperature of an upper mould is controlled at 125° C., a temperature of a lower mould is controlled at 125° C., forming pressure is controlled at 10 MPa, forming time is controlled at 45 seconds, and a semi-finished vehicle interior part is obtained after the compression forming.

The semi-finished vehicle interior part is placed on a cooling tooling fixture for vacuum adsorption, cooling and shaping at room temperature.

Cooling time is controlled at 45 seconds, and a vacuum degree is controlled at −3.5 mbar.

The cooled and shaped semi-finished vehicle interior part is placed on a workbench for burrs to be removed to obtain a finished vehicle interior part.

In an embodiment, a heated mould compression forming process for the vehicle interior part includes steps described below.

The upper PU sheet 10 and the lower PU sheet 11 are coated with glue, respectively.

The upper PU sheet 10 and the lower PU sheet 11 each have a thickness of 10 mm and a weight per unit area of 500 g/m², and a glue volume of an upper or lower surface of the upper PU sheet 10 and a glue volume of an upper or lower surface of the lower PU sheet 11 each are controlled at 450 g/m². A main component of the glue coated is a polyurethane compound.

Pure water or a catalyst is uniformly sprayed on the upper and lower surfaces of the upper PU sheet 10 and the upper and lower surfaces of the lower PU sheet 11 which are coated with the glue.

An amount of the pure water or the catalyst sprayed on the upper or lower surface of the upper PU sheet 10 and an amount of the pure water or the catalyst sprayed on the upper or lower surface of the lower PU sheet 11 each are controlled at 450 g/m².

The upper non-woven fabric 7, the upper glass fiber layer 12, the upper PU sheet 10, the middle glass fiber layer 9, the lower PU sheet 11, the lower glass fiber layer 13, and the lower non-woven fabric 8 are stacked in sequence from top to bottom.

The stacked forming materials are placed in a pressing mould for compression forming.

During the compression forming, a temperature of an upper mould is controlled at 140° C., a temperature of a lower mould is controlled at 140° C., forming pressure is controlled at 16 MPa, forming time is controlled at 80 seconds, and a semi-finished vehicle interior part is obtained after the compression forming.

The semi-finished vehicle interior part is placed on a cooling tooling fixture for vacuum adsorption, cooling and shaping at room temperature.

Cooling time is controlled at 50 seconds, and a vacuum degree is controlled at −5 mbar.

The cooled and shaped semi-finished vehicle interior part is placed on a workbench for burrs to be removed to obtain a finished vehicle interior part.

### Embodiment Three

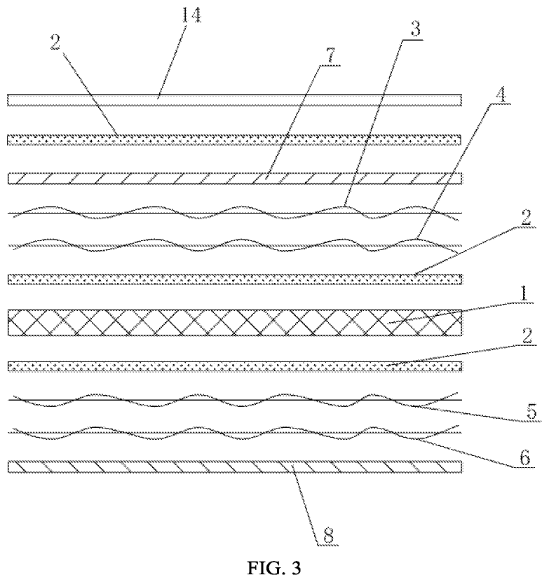

As shown in FIG. 3, this embodiment provides a vehicle interior part. The vehicle interior part includes a PU sheet 1 (i.e., a substrate). An upper reinforcement layer and a lower reinforcement layer are bonded on two sides of the PU sheet 1 through a glue layer 2, respectively, and the upper reinforcement layer and the lower reinforcement layer both adopt a double-layer structure. The upper reinforcement layer includes a first upper glass fiber layer 3 and a second upper glass fiber layer 4, the lower reinforcement layer includes a first lower glass fiber layer 5 and a second lower glass fiber layer 6. A surface of the first upper glass fiber layer 3 is bonded with an upper non-woven fabric 7 (i.e., a first outer layer), a surface of the upper non-woven fabric 7 is bonded with a second outer layer 14, and a surface of the second lower glass fiber layer 6 is bonded with a lower non-woven fabric 8 (i.e., a bottom fabric layer). The PU sheet 1 has a thickness in a range from 2 mm to 10 mm, such as 2 mm, 3 mm, 4 mm, 5 mm, 6 mm, 7 mm, 8 mm, 9 mm, and 10 mm. The PU sheet 1 has a weight per unit area in a range from 30 g/m² to 500 g/m², such as 30 g/m², 50 g/m², 100 g/m², 150 g/m², 200 g/m², 250 g/m², 300 g/m², 350 g/m², 400 g/m², 450 g/m², and 500 g/m². And a glue volume of the glue layer 2 is controlled within a range from 50 g/m² to 450 g/m², such as 50 g/m², 100 g/m², 150 g/m², 200 g/m², 250 g/m², 300 g/m², 350 g/m², 400 g/m², and 450 g/m². The second outer layer 14 has a thickness in a range from 1 mm to 5 mm and a weight per unit area in a range from 200 g/m² to 500 g/m².

In an embodiment, a heated mould compression forming process for the vehicle interior part includes steps described below.

In S100, a first surface and a second surface of the PU sheet 1 are coated with glue, respectively.

The PU sheet 1 has a thickness of 2 mm and a weight per unit area of 30 g/m², and a total glue volume of the first surface and the second surface of the PU sheet 1 is controlled at 50 g/m². A main component of the glue coated is a polyurethane compound.

In S10, pure water or a catalyst is uniformly sprayed on the first surface and the second surface of the PU sheet 1 which are coated with the glue.

An amount of the pure water or the catalyst sprayed on the first surface of the PU sheet 1 and an amount of the pure water or the catalyst sprayed on the second surface of the PU sheet 1 each are controlled at 50 g/m².

In S120, the upper non-woven fabric 7, the first upper glass fiber layer 3, the second upper glass fiber layer 4, the PU sheet 1, the first lower glass fiber layer 5, the second lower glass fiber layer 6, and the lower non-woven fabric 8 are stacked in sequence from top to bottom.

In S130, the stacked forming materials are placed in a pressing mould for compression forming, to obtain a semi-finished vehicle interior part.

During the compression forming, a temperature of an upper mould is controlled at 110° C., a temperature of a lower mould is controlled at 110° C., forming pressure is controlled at 5 MPa, and forming time is controlled at 10 seconds.

In S140, the semi-finished vehicle interior part is placed on a cooling tooling fixture for vacuum adsorption, cooling and shaping at room temperature.

Cooling time is controlled at 40 seconds, and a vacuum degree is controlled at −2 mbar.

In S150, the cooled and shaped semi-finished vehicle interior part is placed on a workbench for burrs to be removed.

In S160, the semi-finished vehicle interior part with burrs removed is placed in a mould or a device, and the second outer layer 14 is bonded to the semi-finished vehicle interior part to obtain a finished vehicle interior part.

A temperature of an upper mould is controlled within a range from 50° C. to 140° C., a temperature of a lower mould is controlled within a range from 50° C. to 140° C., forming pressure is controlled within a range from 2 MPa to 16 MPa, and forming time is controlled within a range from 10 seconds to 80 seconds.

In an embodiment, a heated mould compression forming process for the vehicle interior part includes steps described below.

A first surface and the second surface of the PU sheet 1 are coated with glue, respectively.

The PU sheet 1 has a thickness of 6 mm and a weight per unit area of 250 g/m², and a total glue volume of the first surface and the second surface of the PU sheet 1 is controlled at 250 g/m². A main component of the glue coated is a polyurethane compound.

Pure water or a catalyst is uniformly sprayed on the first surface and the second surface of the PU sheet 1 which are coated with the glue.

An amount of the pure water or the catalyst sprayed on the first surface of the PU sheet land an amount of the pure water or the catalyst sprayed on the second surface of the PU sheet 1 each are controlled at 250 g/m².

The upper non-woven fabric 7, the first upper glass fiber layer 3, the second upper glass fiber layer 4, the PU sheet 1, the first lower glass fiber layer 5, the second lower glass fiber layer 6, and the lower non-woven fabric 8 are stacked in sequence from top to bottom.

The stacked forming materials are placed in a pressing mould for compression forming, to obtain a semi-finished vehicle interior part.

During the compression forming, a temperature of an upper mould is controlled at 125° C., a temperature of a lower mould is controlled at 125° C., forming pressure is controlled at 10 MPa, and forming time is controlled at 45 seconds.

The semi-finished vehicle interior part is placed on a cooling tooling fixture for vacuum adsorption, cooling and shaping at room temperature.

Cooling time is controlled at 45 seconds, and a vacuum degree is controlled at −3.5 mbar.

The cooled and shaped semi-finished vehicle interior part is placed on a workbench for burrs to be removed.

The semi-finished vehicle interior part with the burrs removed is placed in a mould or a device, and the second outer layer 14 is bonded to the semi-finished vehicle interior part with the burrs removed to obtain a finished vehicle interior part.

A temperature of an upper mould is controlled within a range from 50° C. to 140° C., a temperature of a lower mould is controlled within a range from 50° C. to 140° C., forming pressure is controlled within a range from 2 MPa to 16 MPa, and forming time is controlled within a range from 10 seconds to 80 seconds.

In an embodiment, a heated mould compression forming process for the vehicle interior part includes steps described below.

A first surface and a second surface of the PU sheet 1 are coated with glue, respectively.

The PU sheet 1 has a thickness of 10 mm and a weight per unit area of 500 g/m², and a total glue volume of the first surface and the second surface of the PU sheet 1 is controlled at 450 g/m². A main component of the glue coated is a polyurethane compound.

Pure water or a catalyst is uniformly sprayed on the first surface and the second surface of the PU sheet 1 which are coated with the glue.

An amount of the pure water or the catalyst sprayed on the first surface of the PU sheet and an amount of the pure water or the catalyst sprayed on the second surface of the PU sheet each are controlled at 450 g/m².

The upper non-woven fabric 7, the first upper glass fiber layer 3, the second upper glass fiber layer 4, the PU sheet 1, the first lower glass fiber layer 5, the second lower glass fiber layer 6, and the lower non-woven fabric 8 are stacked in sequence from top to bottom.

The stacked forming materials are placed in a pressing mould for compression forming, to obtain a semi-finished vehicle interior part.

During the compression forming, a temperature of an upper mould is controlled at 140° C., a temperature of a lower mould is controlled at 140° C., forming pressure is controlled at 16 MPa, and forming time is controlled at 80 seconds.

The semi-finished vehicle interior part is placed on a cooling tooling fixture for vacuum adsorption, cooling and shaping at room temperature.

Cooling time is controlled at 50 seconds, and a vacuum degree is controlled at −5 mbar.

The cooled and shaped semi-finished vehicle interior part is placed on a workbench for burrs to be removed.

The semi-finished vehicle interior part with the burrs removed is placed in a mould or a device, and the second outer layer 14 is bonded to the semi-finished vehicle interior part with the burrs removed to obtain a finished vehicle interior part.

A temperature of an upper mould is controlled within a range from 50° C. to 140° C., a temperature of a lower mould is controlled within a range from 50° C. to 140° C., forming pressure is controlled within a range from 2 MPa to 16 MPa, and forming time is controlled within a range from 10 seconds to 80 seconds.

### Embodiment Four

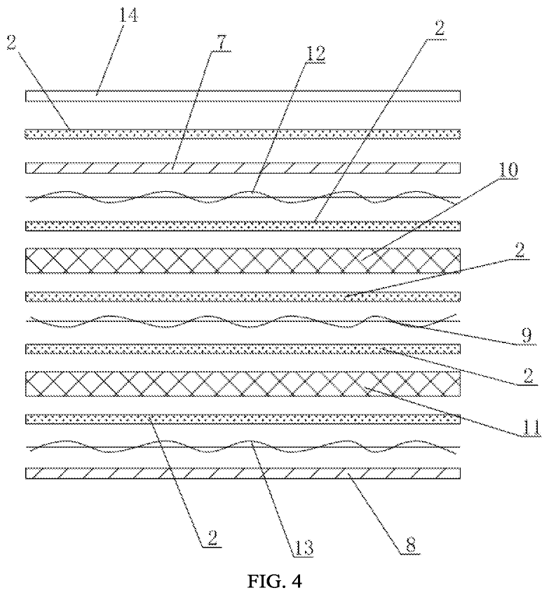

As shown in FIG. 4, this embodiment provides a vehicle interior part. The vehicle interior part includes a substrate. The substrate includes a middle glass fiber layer 9, and an upper PU sheet 10 (i.e., an upper core material) and a lower PU sheet 11 (i.e., a lower core material) are bonded on upper and lower sides of the middle glass fiber layer 9 through a glue layer 2, respectively, A surface of the upper PU sheet 10 is bonded with an upper glass fiber layer 12 through the glue layer 2, and a surface of the upper glass fiber layer 12 is bonded with an upper non-woven fabric 7. A surface of the upper non-woven fabric 7 is bonded with a second outer layer 14, a bottom surface of the lower PU sheet 11 is bonded with a lower glass fiber layer 13 through the glue layer 2, and a bottom surface of the lower glass fiber layer 13 is bonded with a lower non-woven fabric 8. The upper PU sheet 10 and the lower PU sheet 11 each have a thickness in a range from 2 mm to 10 mm, such as 2 mm, 3 mm, 4 mm, 5 mm, 6 mm, 7 mm, 8 mm, 9 mm, and 10 mm. The upper PU sheet 10 and the lower PU sheet 11 each have a weight per unit area in a range from 30 g/m² to 500 g/m², such as 30 g/m², 50 g/m², 100 g/m², 150 g/m², 200 g/m², 250 g/m², 300 g/m², 350 g/m², 400 g/m², 450 g/m², and 500 g/m². And a glue volume of the glue layer 2 is controlled within a range from 50 g/m² to 450 g/m², such as 50 g/m², 100 g/m², 150 g/m², 200 g/m², 250 g/m², 300 g/m², 350 g/m², 400 g/m², and 450 g/m². The second outer layer 14 has a thickness in a range from 1 mm to 5 mm and a weight per unit area in a range from 200 g/m² to 500 g/m².

In an embodiment, a heated mould compression forming process for the vehicle interior part includes steps described below.

The upper PU sheet 10 and the lower PU sheet 11 are coated with glue, respectively.

The upper PU sheet 10 and the lower PU sheet 11 each have a thickness of 2 mm and a weight per unit area of 30 g/m², and a glue volume of an upper or lower surface of the upper PU sheet 10 and a glue volume of an upper or lower surface of the lower PU sheet 11 each are controlled at 50 g/m². A main component of the glue coated is a polyurethane compound.

Pure water or a catalyst is uniformly sprayed on the upper and lower surfaces of the upper PU sheet 10 and the upper and lower surfaces of the lower PU sheet 11 which are coated with the glue.

An amount of the pure water or the catalyst sprayed on the upper or lower surface of the upper PU sheet 10 and an amount of the pure water or the catalyst sprayed on the lower PU sheet 11 is controlled at 50 g/m².

The upper non-woven fabric 7, the upper glass fiber layer 12, the upper PU sheet 10, the middle glass fiber layer 9, the lower PU sheet 11, the lower glass fiber layer 13, and the lower non-woven fabric 8 are stacked in sequence from top to bottom.

The stacked forming materials are placed in a pressing mould for compression forming, to obtain a semi-finished vehicle interior part.

During the compression forming, a temperature of an upper mould is controlled at 110° C., a temperature of a lower mould is controlled at 110° C., forming pressure is controlled at 5 MPa, and forming time is controlled at 10 seconds.

The semi-finished vehicle interior part is placed on a cooling tooling fixture for vacuum adsorption, cooling and shaping at room temperature.

Cooling time is controlled at 40 seconds, and a vacuum degree is controlled at −2 mbar.

The cooled and shaped semi-finished vehicle interior part is placed on a workbench for burrs to be removed.

The semi-finished vehicle interior part is placed in a mould or a device, and the second outer layer 14 is bonded to the semi-finished vehicle interior part to obtain a finished the vehicle interior part.

A temperature of an upper mould is controlled within a range from 50° C. to 140° C., a temperature of a lower mould is controlled within a range from 50° C. to 140° C., forming pressure is controlled within a range from 2 MPa to 16 MPa, and forming time is controlled within a range from 10 seconds to 80 seconds.

In an embodiment, a heated mould compression forming process for the vehicle interior part includes steps described below.

The upper PU sheet 10 and the lower PU sheet 11 are coated with glue, respectively.

The upper PU sheet 10 and the lower PU sheet 11 each have a thickness of 6 mm and a weight per unit area of 250 g/m², and a glue volume of an upper or lower surface of the upper PU sheet 10 and a glue volume of an upper or lower surface of the lower PU sheet 11 each are controlled at 250 g/m². A main component of the glue coated is a polyurethane compound.

Pure water or a catalyst is uniformly sprayed on the upper and lower surfaces of the upper PU sheet 10 and the upper and lower surfaces of the lower PU sheet 11 which are coated with the glue.

An amount of the pure water or the catalyst sprayed on the upper or lower surface of the upper PU sheet 10 and an amount of the pure water or the catalyst sprayed on the upper or lower surface of the lower PU sheet 11 each are controlled at 250 g/m².

The upper non-woven fabric 7, the upper glass fiber layer 12, the upper PU sheet 10, the middle glass fiber layer 9, the lower PU sheet 11, the lower glass fiber layer 13, and the lower non-woven fabric 8 are stacked in sequence from top to bottom.

The stacked forming materials are placed in a pressing mould for compression forming, to obtain a semi-finished vehicle interior part.

During the compression forming, a temperature of an upper mould is controlled at 125° C., a temperature of a lower mould is controlled at 125° C., forming pressure is controlled at 10 MPa, and forming time is controlled at 45 seconds.

The semi-finished vehicle interior part is placed on a cooling tooling fixture for vacuum adsorption, cooling and shaping at room temperature.

Cooling time is controlled at 45 seconds, and a vacuum degree is controlled at −3.5 mbar.

The cooled and shaped semi-finished vehicle interior part is placed on a workbench for burrs to be removed.

The semi-finished vehicle interior part with the burrs removed is placed in a mould or a device, and the second outer layer 14 is bonded to the semi-finished vehicle interior part with the burrs removed to obtain a finished vehicle interior part.

A temperature of an upper mould is controlled within a range from 50° C. to 140° C., a temperature of a lower mould is controlled within a range from 50° C. to 140° C., forming pressure is controlled within a range from 2 MPa to 16 MPa, and forming time is controlled within a range from 10 seconds to 80 seconds.

In an embodiment, a heated mould compression forming process for the vehicle interior part includes steps described below.

The upper PU sheet 10 and the lower PU sheet 11 are coated with glue, respectively.

The upper PU sheet 10 and the lower PU sheet 11 each have a thickness of 10 mm and a weight per unit area of 500 g/m².

A glue volume of an upper or lower surface of the upper PU sheet 10 and a glue volume of an upper or lower surface of the lower PU sheet 11 each are controlled at 450 g/m². A main component of the glue coated is a polyurethane compound.

Pure water or a catalyst is uniformly sprayed on the upper and lower surfaces of the upper PU sheet 10 and the upper and lower surfaces of the lower PU sheet 11 which are coated with the glue.

An amount of the pure water or the catalyst sprayed on the upper or lower surface of the upper PU sheet 10 and an amount of the pure water or the catalyst sprayed on the upper or lower surface of the lower PU sheet 11 each are controlled at 450 g/m².

The upper non-woven fabric 7, the upper glass fiber layer 12, the upper PU sheet 10, the middle glass fiber layer 9, the lower PU sheet 11, the lower glass fiber layer 13, and the lower non-woven fabric 8 are stacked in sequence from top to bottom.

The stacked forming materials are placed in a pressing mould for compression forming to obtain a semi-finished vehicle interior part.

During the compression forming, a temperature of an upper mould is controlled at 140° C., a temperature of a lower mould is controlled at 140° C., forming pressure is controlled at 16 MPa, and forming time is controlled at 80 seconds.

The semi-finished vehicle interior part is placed on a cooling tooling fixture for vacuum adsorption, cooling and shaping at room temperature.

Cooling time is controlled at 50 seconds, and a vacuum degree is controlled at −5 mbar.

The cooled and shaped semi-finished vehicle interior part is placed on a workbench for burrs to be removed.

The semi-finished vehicle interior part with the burrs removed is placed in a mould or a device, and the second outer layer 14 is bonded to the semi-finished vehicle interior part with the burrs removed to obtain a finished vehicle interior part.

A temperature of an upper mould is controlled within a range from 50° C. to 140° C., a temperature of a lower mould is controlled within a range from 50° C. to 140° C., forming pressure is controlled within a range from 2 MPa to 16 MPa, and forming time is controlled within a range from 10 seconds to 80 seconds.

What is claimed is:

1. A vehicle interior part, comprising:
a substrate, a first outer layer, a second outer layer, an upper reinforcement layer, a lower reinforcement layer, and a bottom fabric layer, wherein a first surface and a second surface of the substrate are bonded to a first surface of the upper reinforcement layer and a first surface of the lower reinforcement layer, respectively, a second surface of the upper reinforcement layer is bonded to a first surface of the first outer layer, a second surface of the first outer layer is bonded to the second outer layer, and a second surface of the lower reinforcement layer is bonded to the bottom fabric layer;
wherein the upper reinforcement layer and the lower reinforcement layer are each made of at least one layer of glass fiber filament or glass fiber mat, and the second outer layer is made of a knitted fabric, a chamois fabric, a needled mat, a flock mat, or a loop-pile mat; and
the substrate comprises first and second layers of core materials and a glass fiber reinforcement layer between the first and second layers of core materials, each of the first and second layers of core materials being bonded to the glass fiber reinforcement layer through a glue layer, each of the first and second layers of core materials having a thickness in a range from 2 mm to 10 mm and a weight per unit area in a range from 30 g/m² to 500 g/m², and the glue layer having a weight per unit area in a range from 50 g/m² to 450 g/m².

2. The vehicle interior part of claim 2 or 3, wherein the core material is made of polyurethane.

3. The vehicle interior part of claim 1, wherein the upper reinforcement layer and the lower reinforcement layer each adopt a double-layer structure, the upper reinforcement layer comprises a first upper glass fiber layer and a second upper glass fiber layer, and the lower reinforcement layer comprises a first lower glass fiber layer and a second lower glass fiber layer.

4. The vehicle interior part of claim 1, wherein the upper reinforcement layer, the middle reinforcement layer, and the lower reinforcement layer each adopt a single-layer structure and each are a glass fiber layer.

5. The vehicle interior part of claim 1, wherein the second outer layer has a thickness in a range from 1 mm to 5 mm and a weight per unit area in a range from 200 g/m² to 500 g/m².

6. A composite article comprising:
a multi-layered body in a shape of a vehicle trim component, the multi-layered body including upper and lower fiber layers, a thermoset polymer substrate layer situated between the upper and lower fiber layers, a fabric layer adjacent the lower fiber layer, an upper thermoset adhesive embedding the upper fiber layer and bonding the upper fiber layer to the thermoset polymer substrate, and a lower thermoset adhesive embedding the lower fiber layer and bonding the lower fiber layer and the fabric layer to the thermoset polymer substrate.

7. The composite article as recited in claim 6, wherein the upper and lower fiber layers are each multi-layered.

8. The composite article as recited in claim 7, wherein at least one of the upper and lower fiber layers are woven.

9. The composite article as recited in claim 7, wherein the upper and lower fiber layers includes glass fibers.

10. The composite article as recited in claim 7, wherein the upper and lower fiber layers have a weight per unit area of 80g/m² to to 200 g/m² to.

11. The composite article as recited in claim 7, further comprising an additional thermoset polymer substrate adjacent the upper fiber layer such that the upper fiber layer is between the thermoset polymer substrate and the additional thermoset polymer substrate.

12. The composite article as recited in claim 7, wherein the thermoset polymer substrate is a porous foam.
